(19) United States
(12) Patent Application Publication
(10) Pub. No.: US 2023/0267642 A1
(43) Pub. Date: Aug. 24, 2023

(54) FIDUCIAL LOCATION

(71) Applicants: PURDUE RESEARCH FOUNDATION, West Layfayette, IN (US); Hewlett-Packard Development Company, L.P., Spring, TX (US)

(72) Inventors: Yujian XU, West Lafayette, IN (US); Stephen Bernard Pollard, Bristol (GB); Robert ULICHNEY, Stow, MA (US); Matthew D GAUBATZ, Seattle, WA (US); Jan Philip ALLEBACH, West Lafayette, IN (US)

(73) Assignees: PURDUE RESEARCH FOUNDATION, West Layfayette, IN (US); Hewlett-Packard Development Company, L.P., Spring, TX (US)

(21) Appl. No.: 18/015,878

(22) PCT Filed: Jul. 15, 2020
(86) PCT No.: PCT/US2020/042069

§ 371 Date: Jan. 12, 2023

(51) Int. Cl. G06T 7/73

(52) U.S. Cl. CPC G06T 7/73

(57) ABSTRACT

Examples of methods for fiducial location are described herein. In some examples, a method may include estimating a first location of an unidentified fiducial based on image coordinates and grid coordinates of a set of contiguous fiducials. In some examples, the method may include determining that a candidate fiducial is a fiducial based on comparing the first location with a second location of the candidate fiducial.

### BACKGROUND

Items may be labeled or marked. For example, items may be labeled or marked to convey information about the items. Some items may be labeled with text, characters, or symbols. For instance, labeling may be utilized to inform a person about an item, such as materials in clothing, washing directions for clothing, nutrition information for food products, prices of goods, warning labels for machinery, usage directions for pharmaceutical products, etc. In some cases, labeling may be utilized for tracking items (e.g., items for inventory tracking or purchase) or for automated procedures (e.g., detection, sorting, quality control, etc.).

### BRIEF DESCRIPTION OF THE DRAWINGS

FIG. 1 is a flow diagram illustrating an example of a method for determining fiducial location;

FIG. 2 is a flow diagram illustrating an example of a method for estimating fiducial location;

FIG. 3 is a flow diagram illustrating an example of a method for estimating fiducial location based on grid coordinates;

FIG. 4 is a block diagram of an example of an apparatus that may be used in fiducial location;

FIG. 5 is a block diagram illustrating an example of a computer-readable medium for determining fiducial location;

FIG. 6 is a diagram illustrating an example of a line crossing in accordance with some examples of the techniques described herein;

FIG. 7 is a diagram illustrating an example of an image subset in accordance with some examples of the techniques described herein;

FIG. 8A is a diagram illustrating an example of a first approach for determining fiducial location;

FIG. 8B is a diagram illustrating an example of a second approach for determining fiducial location; and

FIG. 9 is a diagram illustrating an example of an image of a cylindrical object with a detected fiducial pattern in accordance with some examples of the techniques described herein.

### DETAILED DESCRIPTION

Some examples of the techniques described herein are related to fiducial patterns. A fiducial pattern is a pattern of marks. Examples of marks may include dots, lines, crosses, characters, and/or symbols, etc. In some examples, a fiducial pattern may be an arrangement of marks in a recurring pattern. For instance, a fiducial pattern may include marks that are arranged according to a grid (e.g., polygonal grid, rectangular grid, triangular grid, hexagonal grid, etc.), where the marks are positioned at grid intersections and/or vertices. In some examples, the marks and/or grid may be uniform or non-uniform. Marks that correspond to a fiducial pattern may be referred to as fiducial marks (e.g., fiducial dots). In some examples, the fiducial pattern may include a set of halftone dots.

In some examples, a fiducial pattern may appear on an object. For example, an object may exhibit a fiducial pattern and/or a fiducial pattern may be placed, printed, labeled, and/or marked, etc., on an object. In some examples, the object may be a curved and/or non-planar object. For instance, the fiducial pattern may appear on a curved surface of the object. In some examples, the object may be a three-dimensional (3D) object, where the fiducial pattern appears on a non-planar surface of the 3D object. A viewing perspective of the object and/or the curved and/or non-planar surface of an object may result in a distorted (e.g., bent, modified, non-planar, etc.) appearance of the fiducial pattern.

Some approaches to recovering a fiducial pattern may constrain the fiducial pattern to flat or planar surfaces. This constraint may limit marking for some objects (e.g., 3D printed objects), where a flat surface of the objects has a limited size, is inaccessible, or is nonexistent.

Some examples of the techniques described herein may allow detecting a fiducial pattern on non-planar and/or curved surfaces. In some examples, an image of the surface may be segmented into an image subset or subsets (e.g., tiles, regions, etc.) that correspond to portions of an object that are approximately planar. In some examples, fiducial pattern detection may start by detecting a fiducial pattern subset in an image or image subset. In some examples, pattern detection may proceed by extending the fiducial pattern subset. In some examples, pattern detection may continue until detection is performed for an area of the image in which the fiducial pattern is visible.

Some examples of the techniques described herein may be utilized to estimate and/or determine a location of an unidentified fiducial. An unidentified fiducial is a non-identified fiducial or an unidentified location relative to a set of identified fiducials. An identified fiducial is a mark that is determined to be a fiducial (e.g., an actual fiducial) in a fiducial pattern. A candidate fiducial is a mark that is potentially a fiducial. For example, a candidate fiducial or fiducials may be detected. Some examples of the techniques described herein may be utilized to determine that a candidate fiducial is a fiducial to fill a position and/or location of an unidentified fiducial.

Throughout the drawings, identical reference numbers may designate similar, but not necessarily identical, elements. Similar numbers may indicate similar elements. When an element is referred to without a reference number, this may refer to the element generally, without necessary limitation to any particular figure. The figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

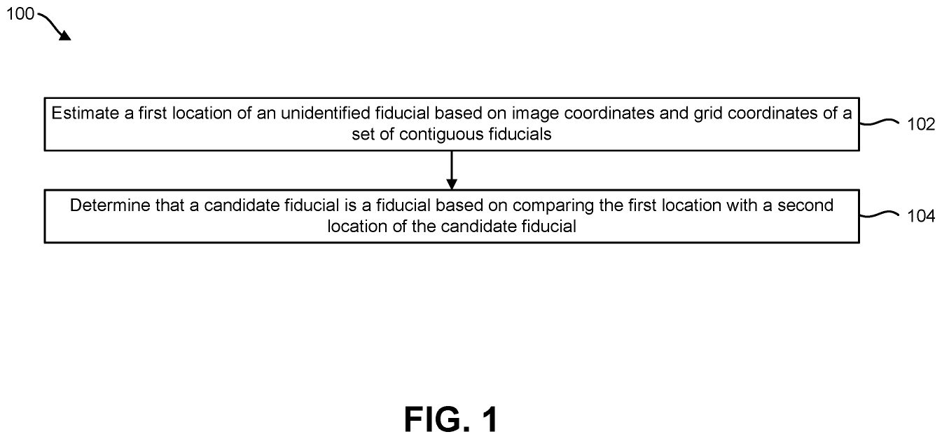

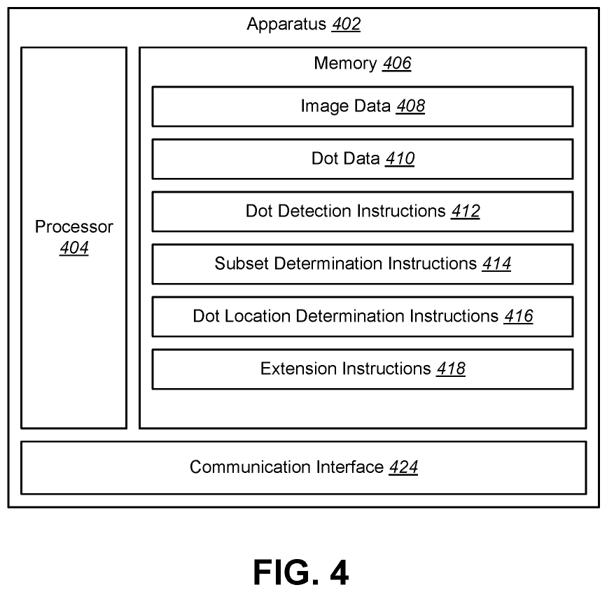

FIG. 1 is a flow diagram illustrating an example of a method 100 for determining fiducial location. The method 100 and/or a method 100 element or elements may be performed by an apparatus (e.g., electronic device, computing device, scanner, server, etc.). For example, the method 100 may be performed by the apparatus 402 described in relation to FIG. 4.

An image is optical data. Examples of an image include a digital photograph, a set of pixels, data representing optical values (e.g., color and/or brightness), etc. An image of an object is an image that indicates and/or depicts an object. For example, an image of an object may be an array of pixel values, where one, some, or all of the pixel values correspond to the object or an appearance of the object. In some examples, the apparatus may capture an image. For instance, the apparatus may utilize an integrated image sensor to capture the image. In some examples, the apparatus may receive the image from another device (e.g., remote image sensor, remote camera, linked camera, networked device, etc.). In some examples, an object may include a fiducial pattern (e.g., a pattern of marks, dots, lines, crosses, symbols, etc.) and/or may include a marking of a fiducial pattern. In some examples, the fiducial pattern may appear in the image. For instance, an image with a resolution (e.g., 600 dots per inch (dpi), 300 dpi or another resolution) may depict fiducial marks on a surface of the object. In some examples, some of the fiducial marks appearing in the image may be spaced (by 6, 8, 10 pixels, etc., for example) according to the capture distance and/or perspective of the image.

An image space is a space corresponding to an image. For example, an image space may be denoted by a coordinate system over dimensions of an image (e.g., two-dimensional (2D)) image. In some examples, an image space may be expressed in units of pixels and/or distances (e.g., height, width, etc.). An image coordinate is a coordinate in an image space. For instance, a 2D image coordinate may include two coordinate values indicating a location in the image space. In some examples, an image coordinate may be expressed in terms of floating-point and/or fixed-point numbers. For example, coordinate values in the image space may allow for expressing fractional quantities and/or locations in the image space.

An image subset is a part or portion of an image. For example, an image subset may be a region of an image and/or a portion of data of the image. In some examples, an image subset may be a rectangular subset (e.g., tile, etc.) of the image data. In some examples, image subsets of an image may have set (e.g., fixed) dimensions (e.g., height and width in pixels, inches, centimeters, etc.) or dimensions for the image subsets may be determined. For example, the apparatus may determine image subset dimensions as a proportion of an image dimension or dimensions (e.g., image width/5 by image height/5, etc.). In some examples, image subsets may overlap with each other. For instance, a second image subset may overlap a first image subset in an overlapping region. In some examples, the overlapping region may include a portion (e.g., 10%, 25%, 50%, etc.) of the first image subset. In some examples, image subsets may not overlap with each other. In some examples, image subsets of an image may cover an image. In some examples, image subsets may cover a portion of an image (e.g., a portion or portions of the image corresponding to an object or objects). For instance, an apparatus may detect a portion of an image in which an object is located. The image subsets may cover the portion of the image in which the object is located. In some examples, image subsets may cover a central portion of an image (e.g., within a range from a center of the image).

In some examples, an image subset may include a quantity of samples of fiducial marks (e.g., dots). In some examples, image subset size may be determined as a fixed portion of the image relative to the size of the image (e.g., each image subset size may be determined as having a width and/or height that are a fixed portion of the image width and/or height (e.g., 5%, 10%, 12.5%, etc.)). In some examples, the image subset size may be determined in order to include a minimum number of marks or more per subset. In some examples, the image subset size may be restricted to allow processing of all subsets to be completed in a fixed amount of time.

A fiducial pattern subset is a part or portion of a fiducial pattern. For example, a fiducial pattern subset may include a subset of marks (e.g., dots, lines, crosses, characters, and/or symbols, etc.) of a fiducial pattern. In some examples, the fiducial pattern subsets may be subsets of a fiducial pattern grid that includes fiducial dots (e.g., fiducial dots on a non-planar or curved surface of the object). In some examples, the image subsets may exclude a portion or portions of the image that do not include the object.

In some examples, a fiducial pattern may be in a sparse arrangement on an object's surface. For instance, fiducial marks (e.g., dots) may be arranged in a grid where the marks are spaced apart by a fixed amount (e.g., 2 millimeters (mm), 3.4 mm, etc.). In other examples, fiducial patterns may be provided in a denser arrangement.

In some examples, the apparatus may enhance an image of an object. For example, the apparatus may perform image filtering that enhances a difference (e.g., color difference and/or brightness difference) between marks of the fiducial pattern and other portions of the image. In some examples, the apparatus may enhance the image by applying a band pass filter to the image. For instance, the apparatus may apply a Difference of Gaussian (DoG) operator. In some examples, the DoG operator may amplify the presence of marks (e.g., dots) at a given scale. For an image with high-definition resolution (e.g., 1280×720 pixels), for instance, the image may be filtered with a high frequency Gaussian filter that may have a sigma (standard deviation) of 1.0 pixels and with a low frequency filter that may have a sigma of 6.0 pixels. In some examples, different DoG parameters may be utilized for different resolution sensors, viewing distances, and/or mark sizes. The difference of the filtered images may be a DoG-filtered image, which may be an example of an enhanced image. In some examples, the filters may be differenced to produce a single DoG filter that may be applied to the image, which approach may not utilize a separable property of the individual Gaussian filters that enables the two-dimensional (2D) N×N filter to be reduced to the application of a pair of one-dimensional (1 D) 1×N filters in orthogonal directions.

In some examples, the apparatus may detect marks (e.g., mark locations in the image and/or image subsets). For example, the apparatus may search the image and/or image subsets for marks based on mark size, shape, color, brightness, and/or difference relative to other parts of the image (e.g., fiducial pattern background). In some examples, the apparatus may detect mark locations by determining local peaks and/or inverse peaks in an enhanced image (e.g., DoG-filtered image). For example, locations (e.g., pixels) in the image with a maximum or minimum value (e.g., brightness value) within a local neighborhood (e.g., 10×10 pixel neighborhood) may be detected as mark locations. In some examples, locations (e.g., locations of pixels) that meet a criterion (e.g., pixel(s) with a threshold brightness) may be detected as mark locations. For instance, locations associated with marks may be determined as locations of arrangements of pixels that satisfy the criterion. In some examples, non-maximum suppression may be used to ignore weaker marks. For instance, some marks that satisfy a given criterion to a lesser extent than other marks may be ignored. Other approaches may be utilized in other examples (e.g., mark shape correlation, color detection, etc.). Detecting marks may result in a representation of the locations of marks relative to the image. The locations may be utilized to determine the fiducial pattern subsets.

In some examples, a detected mark may be a candidate fiducial. For instance, locations of detected marks may be locations of candidate fiducials. In some examples, the locations of candidate fiducials may be expressed in the image space (e.g., in fixed-point and/or floating-point numbers). For example, each candidate fiducial location may be expressed as coordinates in the image space. In some examples, the candidate fiducial locations may be stored in a data structure. For instance, the candidate fiducial locations may be stored in an array (e.g., 2D array), table, matrix, list, etc. In some examples, the candidate fiducial locations may be stored in a 2D array indexed according to integers. For instance, each column of the 2D array may correspond to an integer index and each row of the 2D array may correspond to an integer index. In some examples, each cell of the 2D array may correspond to a pixel. In some examples, each cell may correspond to an area of the image (e.g., a quantity of pixels or sub-pixels). In some examples, the candidate fiducial locations may be stored in the 2D array according to the index. For instance, the coordinates may be stored in a cell of the array in accordance with rounded coordinate values. For example, a candidate fiducial location with coordinates (2.1, 2.4) (in units of pixels, for instance) may be stored in a cell of the 2D array with indices (2, 2). For instance, the coordinate values (2.1, 2.4) may be associated with indices (2, 2) in the 2D array.

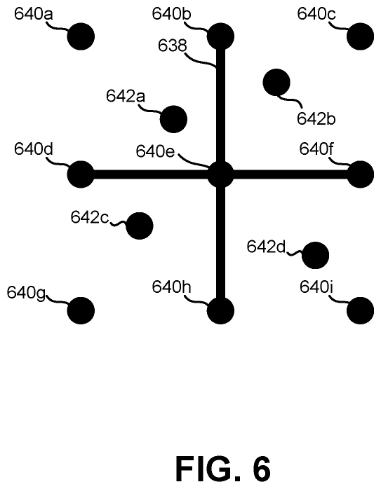

In some examples, the apparatus may detect pattern structures. A pattern structure is a relationship between marks (e.g., candidate fiducials). For instance, a pattern structure may be a sub-structure of a fiducial pattern and/or grid. Examples of a pattern structure may include lines between marks, line crossings, shapes formed with marks, etc. For instance, the apparatus may detect line crossings (e.g., orthogonal line crossings) based on mark positions. For example, a line crossing may include five marks, where a line of three of the marks intersects (e.g., approximately orthogonally intersects) another line of three of the marks at a central mark. In some examples, line crossings may be uniquely defined with respect to a mark (e.g., central mark). An example of a pattern structure is illustrated in FIG. 6. In some examples, other pattern structures (besides line crossings) may be used. For instance, other pattern structures corresponding to a grid may be utilized. For example, triangles, rectangles, squares, hexagons, etc., may be used. A fiducial pattern and/or fiducial pattern subset may include a pattern structure or pattern structures.

In some examples, a distribution of nearest mark distances (that may be larger than a minimum detection distance, for instance) may be determined and used to define a local region within which potential pattern structures (e.g., line crossings), around each mark are selected. For instance, the apparatus may determine a distance to a nearest neighbor mark for each mark (e.g., each detected mark position). For example, the apparatus may determine a geometric distance (e.g., Euclidean distance in the image in terms of pixels, inches, centimeters, and/or another unit) from each mark to a nearest neighbor mark. The set of distances corresponding to each mark may form a distribution. In some examples, local region size may be determined based on the distribution. For instance, a radius of the local region may be defined as three times the 80th percentile of the distribution (where distances that are less than a limiting dot pitch may be ignored, for example). Other approaches to define a radius of the local region are possible, including approaches based on the distribution noted above or approaches without recourse to such a distribution (e.g., static radius). Within the local region (e.g., radius), potential pattern structures around each mark may be selected.

In some examples, the apparatus may find a pattern structure (e.g., most likely pattern structure) within the local region around each mark. For instance, the position of each local region may be defined relative to each respective mark (e.g., centered at each respective mark). In some examples, pattern structure detection may proceed by finding first dimension candidates (e.g., vertical and/or “north-south” candidates) and second dimension candidates (e.g., horizontal and/or “east-west” candidates) that are approximately orthogonal (within a range, such as 5 degrees, for instance). In some examples, first dimension candidates may be within 45 degrees (or less) of a vertical direction in the image with respect to the mark under consideration. In some examples, to be a valid pair, three marks (e.g., dots) of a first dimension pair including the central mark (around which the local region may be defined) may be approximately co-linear. First dimension mark pairs may be approximately equally spaced on either side of the central mark, depending on a percentage length difference (longer to shorter). In some examples, a percentage length difference range may be set at 10% or another value. In some examples, the percentage length difference range may relate to a slope difference in the plane of the surface from which the image is captured of approximately 25 degrees (e.g., arccos of 0.9 assuming orthogonal projection). Second dimension pairs may be found with a similar approach in some examples.

In some examples, first dimension and second dimension pairs may have similar lengths to satisfy the percentage length difference range. For instance, the apparatus may detect pattern structures that satisfy an angular criterion (e.g., lines within an angular range of orthogonality) and/or a percentage length difference criterion (e.g., lines within the length difference criterion range). Other criteria may be utilized in other examples. In ambiguous cases where multiple line crossings satisfy the criteria within the local region of a mark, a line crossing with a smaller size may be selected in some examples. In some examples, multiple candidate line crossings at each mark may be determined. A candidate line crossing may be selected (and/or other candidate line crossings discarded) that allows a closer connection with other line crossing candidates and/or that more closely aligns with a fiducial pattern subset. In some examples, pattern structures may be connected if a line of a pattern structure overlaps with a line of another pattern structure (e.g., neighboring pattern structure). In some examples, pattern structures may be connected if a line of a pattern structure forms an angle with a line of another pattern structure (e.g., neighboring pattern structure) that is within an angular threshold (e.g., 1 degree, 2 degrees, 3.5 degrees, 5 degrees, etc.). In some examples, another criterion or criteria may be utilized to determine whether pattern structures are connected. A fiducial pattern subset may include a pattern structure or connected pattern structures.

In some examples, connected pattern structures may be contiguous. For instance, a set or group of pattern structures that are connected may be deemed contiguous pattern structures. In some examples, a set or group of candidate fiducials that are connected may be deemed contiguous candidate fiducials.

In some examples, the apparatus may perform mark detection and/or pattern structure detection in an image subset or subsets. For example, mark detection and/or pattern structure detection may be performed in an image subset or subsets (e.g., subsets within a range from a center of the image).

The apparatus may select a fiducial pattern subset. In some examples, the apparatus may compare fiducial pattern subsets and/or a fiducial pattern subset aspect or aspects (e.g., number of marks, range, area, and/or lowest mean square error between sets of locations (e.g., computed and estimated locations) with an applied homography) to select a fiducial pattern subset. For example, the apparatus may select, from an image subset, a fiducial pattern subset that includes a greatest number of marks (e.g., connected marks, contiguous pattern structures, etc.), that covers a largest area, that extends over a greatest range, and/or that has a lowest mean square error after applying a homography. For instance, a selected fiducial pattern subset may be larger than the other fiducial pattern subsets in terms of number of marks, area, and/or range. In some approaches, in a case where multiple fiducial pattern subsets have a largest size, one of the fiducial pattern subsets may be selected (at random or in accordance with a criterion, such as a spatial criterion, for instance). In some examples, the apparatus may compare fiducial pattern subsets (e.g., fiducial pattern subsets and/or contiguous pattern structures) from each image subset to select a fiducial pattern subset from the image subsets (e.g., fiducial pattern subset with a greatest number of marks, greatest range, greatest area, and/or lowest mean square error with an applied homography).

In some examples, the apparatus may detect a set of contiguous fiducials. For instance, the apparatus may determine the selected fiducial pattern as described above and designate marks and/or candidate fiducials within the selected fiducial pattern subset as the set of contiguous fiducials. For example, the selected fiducial pattern subset may include a set of contiguous fiducials. For instance, the marks and/or candidate fiducials in the selected fiducial pattern subset may be determined as and/or deemed to be a set of contiguous fiducials. For instance, the candidate fiducials included in the selected fiducial pattern subset may be designated as identified fiducials. In some examples, the set of contiguous fiducials may be an initial set of contiguous fiducials for detecting additional fiducials and/or for expanding the set of contiguous fiducials. In some examples, each contiguous fiducial may be expressed in the image space (e.g., image coordinates). For instance, the apparatus may store image coordinates of the set of contiguous fiducials.

In some examples, the apparatus may assign a grid coordinate to each fiducial in the set of contiguous fiducials. A grid coordinate is a set of values corresponding to a grid. For instance, a grid coordinate may be expressed as two integer values, where the integer values indicate a location on a grid. In some examples, the apparatus may assign an origin grid coordinate of (0, 0) to a fiducial and may assign further grid coordinates to the other fiducials in the set of contiguous fiducials based on spatial relationships to the origin grid coordinate. For instance, the apparatus may assign the origin grid coordinate to a selected fiducial (e.g., fiducial with a lowest image coordinate, fiducial with a median image coordinate, fiducial with a highest image coordinate, a randomly selected fiducial, etc.). Additional grid coordinates may be assigned based on a direction relative to the origin grid coordinate. For instance, a fiducial that is connected to the origin grid coordinate in a first direction may be assigned an increased (e.g., +1) integer value, and additional grid coordinates in the first direction may be assigned increasing (e.g., +2, +3, etc.) integer values. A fiducial that is connected to the origin grid coordinate in a second direction that is opposite from the first direction may be assigned a decreased (e.g., −1) integer value, and additional grid coordinates in the second direction may be assigned decreasing (e.g., −2, −3, etc.) integer values. The grid coordinates may be assigned in multiple (e.g., two) dimensions for each fiducial of the set of contiguous fiducials. In some examples, the apparatus may store the grid coordinates in a data structure (e.g., queue, stack, etc.). The data structure may be utilized to traverse through grid coordinates. For instance, some approaches of the techniques described herein may add grid coordinates to the data structure as grid coordinates are traversed. In some cases, a grid coordinate (e.g., added grid coordinate, neighboring grid coordinate) may correspond to an unidentified fiducial. For instance, grid coordinate(s) may correspond to and/or represent unidentified fiducial(s) and/or identified fiducial(s). A location or locations of unidentified fiducials may be estimated in accordance with some examples of the techniques described herein.

In some examples, image coordinates of identified fiducials (e.g., fiducials in the set of contiguous fiducials) and corresponding grid coordinates may be stored in a mapped set. A mapped set is a data structure (e.g., dictionary, array, table, etc.) that maps or associates values. For example, the mapped set may map an image coordinate to a corresponding grid coordinate for a fiducial or fiducials (e.g., identified fiducial(s)). In some examples, image coordinates and/or grid coordinates may be added to the mapped set as fiducials are identified and/or as the set of contiguous fiducials is expanded.

The apparatus may estimate 102 a first location of an unidentified fiducial based on image coordinates and grid coordinates of a set of contiguous fiducials. For example, the apparatus may utilize image coordinates and grid coordinates around an unidentified fiducial to estimate the first location of the unidentified fiducial. In some examples, the apparatus may utilize image coordinates corresponding to grid coordinates around the unidentified fiducial (e.g., around a grid coordinate of an unidentified fiducial) to estimate the first location.

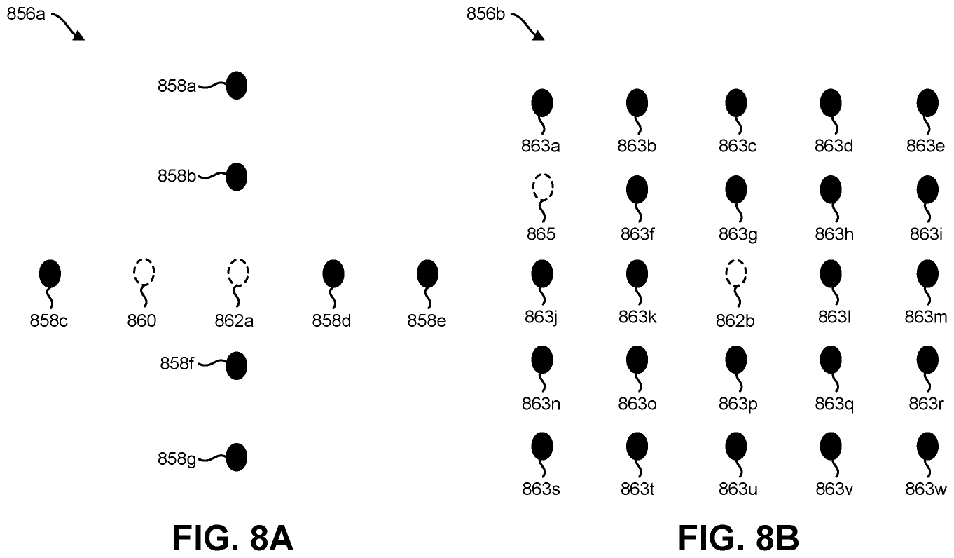

In some examples, estimating 102 the first location of the unidentified fiducial may include calculating the first location based on an image coordinate pair or pairs corresponding to a neighboring grid coordinate pair or pairs. A neighboring grid coordinate is a grid coordinate next to a current grid coordinate (e.g., a grid coordinate corresponding to the unidentified fiducial) within a range. For instance, assume that the unidentified fiducial has a corresponding grid coordinate (m, n). Neighboring grid coordinates within a range of 2 may include (m−2, n), (m−1, n), (m+1, n), (m+2, n), (m, n−2), (m, n−1), (m, n+1), and (m, n+2). A neighboring grid coordinate pair may include a pair of neighboring grid coordinates in one direction from a current grid coordinate (e.g., a grid coordinate corresponding to the unidentified fiducial). For instance, neighboring grid coordinate pairs from (m, n) may include a first pair at (m−2, n) and (m−1, n), a second pair at (m+1, n) and (m+2, n), a third pair at (m, n−2) and (m, n−1), and a fourth pair at (m, n+1) and (m, n+2). An example is provided in relation to FIG. 8A.

In some examples, the apparatus may utilize an image coordinate pair or pairs corresponding to a neighboring grid pair or pairs to calculate an image coordinate estimate or estimates of the unidentified fiducial. In some examples of an intersection approach, if neighboring image coordinate pairs for different directions (e.g., north-south pair and east-west pair) are available, an image coordinate estimate may be determined at an intersecting point between lines through the neighboring image coordinate pairs for different directions. In some examples of a point approach, the apparatus may obtain (e.g., extract from the mapped set) a first image coordinate k₁ and a second image coordinate k₂ corresponding to a neighboring grid pair, where k₁ is nearer to the unidentified fiducial than k₂. In some examples, the apparatus may calculate an image coordinate estimate as 2k₁-k₂ for a neighboring grid pair or pairs. The apparatus may average the image coordinate estimates to estimate the first location. In some examples, the intersection approach, the point approach, or a combination of the intersection approach and the point approach may be utilized. For example, the intersection approach may be utilized when neighboring image coordinate pairs in different directions are available, or the point approach may be utilized when neighboring image coordinate pairs are unavailable and/or when one pair is available at an image space border. In a case that a neighboring grid coordinate does not have a corresponding image coordinate, the image coordinate estimate calculation for that neighboring grid coordinate pair may not be performed (e.g., may be skipped, may be designated as “none,” etc.). In a case that an image coordinate estimate is not performed for the neighboring grid coordinate pairs (e.g., for all of the neighboring grid coordinate pairs in four directions), the first location estimation may be deemed “none” and/or a failure. In some examples, another approach (e.g., the following approach) may be utilized to estimate the first location in a case that the first location estimate is deemed “none” and/or a failure.

In some examples, estimating the first location of the unidentified fiducial may include finding first image coordinates corresponding to first grid coordinates within a window from (e.g., centered at) the unidentified fiducial. A window is a 2D range. For instance, the apparatus may extract, from the mapped set, first image coordinates corresponding to first grid coordinates within a N×N window (e.g., 5×5 window, 7×7 window, 9×9 window, etc.) from the unidentified fiducial, where N×N denotes a window size. For example, the apparatus may extract first image coordinate(s) corresponding to a range of (m±3, n±3) for N=7.

The apparatus may calculate a homography (e.g., rotation, translation, scaling, and/or perspective projection) between the first image coordinates and the first grid coordinates. For example, the apparatus may calculate a rotation, translation, scaling, and/or perspective projection between the first image coordinates and the first grid coordinates. In some approaches, the homography may be calculated if 2N or more image coordinates are found within the window. For example, if less than or not more than 2N image coordinates are found within the window, the first image determination may be deemed as “none” and/or a failure. In some examples, a different image coordinate quantity (besides 2N) may be utilized. An example is provided in relation to FIG. 8B.

The apparatus may calculate the first location based on the homography. For example, the apparatus may apply the homography to the grid coordinate (e.g., (m, n), the grid coordinate of the unidentified fiducial) to produce the first location.

The apparatus may determine 104 that a candidate fiducial is a fiducial (e.g., actual fiducial) based on comparing the first location with a second location of the candidate fiducial. For example, the apparatus may find a second location of a candidate fiducial that is nearest to the first location. For instance, the apparatus may look up, from a data structure, a candidate fiducial(s) that is within a range (e.g., (±1, ±1), (±2, ±2), etc., of the data structure index) from a rounded first location. In some examples, the apparatus may calculate a distance (e.g., Euclidean distance) between the first location and the second location. The candidate fiducial may be determined as a fiducial in a case that the distance is less (and/or not more than) than a threshold distance. For example, comparing the first location with the second location of the candidate fiducial may include determining that the second location of the candidate fiducial is within a threshold distance from the first location. In some examples, the apparatus may determine the threshold distance as T=D/8, where D is an average distance between two adjacent fiducials (e.g., image coordinates of adjacent fiducials) around the unidentified fiducial and/or first location. Adjacent fiducials are fiducials that are situated directly next to (e.g., above and below, laterally next to, etc.) each other in a space. In some examples, adjacent fiducials may be fiducials such that in the grid coordinate space, the respective locations may appear as contiguous entries in the grid in a dimension. In some examples, adjacent fiducials may be fiducials that may appear at a spacing that allows an expected location of the candidate fiducial to be extrapolated from the respective locations of the fiducials. In some examples, a different threshold (e.g., D/9, D/7.5, etc.) may be utilized.

In some examples, the apparatus may map the candidate fiducial to a first grid coordinate in the mapped set in response to determining that the candidate fiducial is a fiducial (e.g., actual fiducial). For instance, the apparatus may store the image coordinate of the candidate fiducial in association with the first grid coordinate in the mapped set in response to determining that the candidate fiducial is a fiducial.

In some examples, the apparatus may add a neighboring grid coordinate or coordinates of the first grid coordinate to a data structure (e.g., queue, stack, etc.). For instance, in a case that the candidate fiducial is a fiducial, the apparatus may add neighboring grid coordinates within a range (e.g., (m−2, n), (m−1, n), (m+1, n), (m+2, n), (m, n−2), (m, n−1), (m, n+1), and (m, n+2)) to the data structure (e.g., queue, stack, etc.). Adding the neighboring grid coordinate(s) to the data structure may enable extending the grid coordinates, for which a location or locations of an unidentified fiducial or unidentified fiducials may be estimated. This change may enable extending the fiducial pattern (e.g., set of contiguous fiducials). Some examples of the techniques for extending, expanding, and/or growing a fiducial pattern described herein may be based on grid coordinates (e.g., a grid coordinate space).

In some examples, the apparatus may add the first grid coordinate to a traversed coordinate set. A traversed coordinate set is a data structure (e.g., hash set, array, etc.). For example, the traversed coordinate set may include a grid coordinate or grid coordinates for which a fiducial has been identified. For instance, the method 100 may be repeated for a grid coordinate or grid coordinates that are not included in the traversed coordinate set. In some examples, the first grid coordinate may be added to the traversed coordinate set in a case that the candidate fiducial is a fiducial.

In some examples, an element or elements of the method 100 may be omitted or combined. In some examples, the method 100 may include one, some, or all of the operations, elements, etc., described in relation to any of FIGS. 1-9.

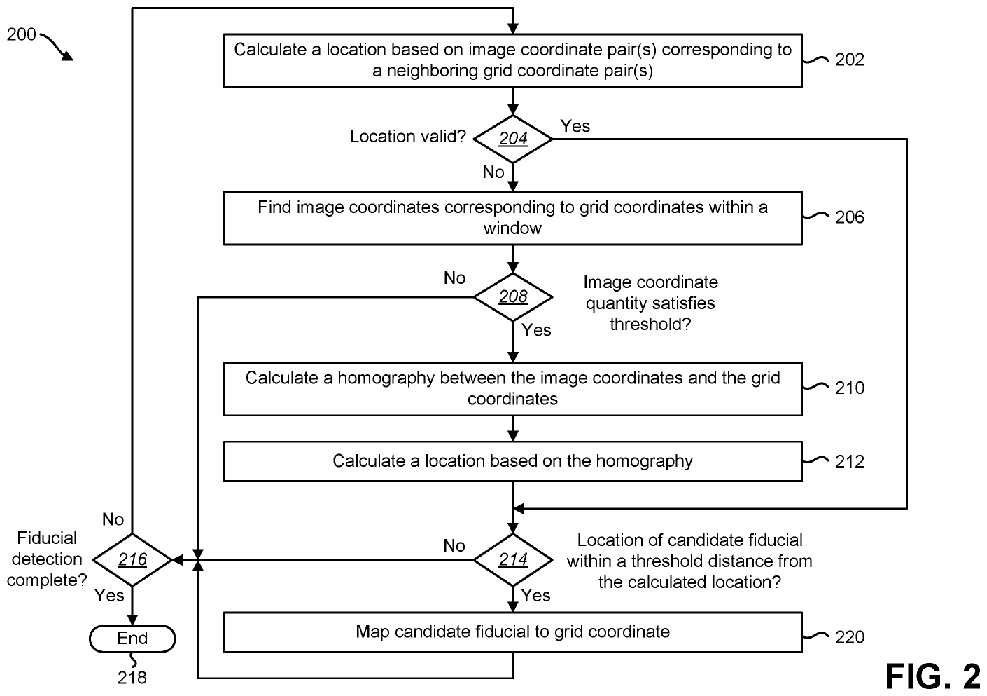

FIG. 2 is a flow diagram illustrating an example of a method 200 for estimating fiducial location. The method 200 may be an example of an aspect or aspects of the method 100 described in relation to FIG. 1. The method 200 and/or a method 200 element or elements may be performed by an apparatus (e.g., electronic device, computing device, server, smartphone, laptop computer, tablet device, scanning device, etc.). For example, the method 200 may be performed by the apparatus 402 described in relation to FIG. 4.

The apparatus may calculate 202 a location based on an image coordinate pair or pairs corresponding to a neighboring grid coordinate pair or pairs. In some examples, calculating 202 the location may be performed as described in relation to FIG. 1.

The apparatus may determine 204 whether the location is valid. In some examples, determining 204 whether the location is valid may be performed as described in relation to FIG. 1. For example, the apparatus may determine whether a location was able to be calculated based on an image coordinate pair or pairs. For instance, if the location is an image coordinate (and not “none” or a failed location calculation, for example), the location may be valid.

In a case that the location is valid, the apparatus may determine 214 whether a location of a candidate fiducial (e.g., nearest candidate fiducial) is within a threshold distance from the calculated location. In some examples, determining 214 whether the location of the candidate fiducial is within a threshold distance from the calculated location may be performed as described in relation to FIG. 1. For example, the apparatus may calculate a distance (e.g., Euclidean distance) between the location of the candidate fiducial and the calculated location. The distance may be compared to the threshold distance.

In a case that the location is not valid (e.g., the location calculation yielded “none” or a failure), the apparatus may find 206 image coordinates corresponding to grid coordinates within a window. In some examples, finding 206 the image coordinates may be performed as described in relation to FIG. 1. For example, the apparatus may extract, from a mapped set, any image coordinates corresponding to the grid coordinates within the window.

The apparatus may determine 208 whether an image coordinate quantity satisfies a threshold. In some examples, determining 208 whether the image coordinate quantity satisfies a threshold may be performed as described in relation to FIG. 1. For instance, the apparatus may determine whether the image coordinates (corresponding to the grid coordinates within a window) is greater than or at least (e.g., ≥) a threshold (e.g., 2N).

In a case that the image coordinate quantity does not satisfy the threshold, the apparatus may determine 216 whether fiducial detection is complete. For example, the apparatus may determine whether a data structure (e.g., queue, stack) is empty and/or whether all grid coordinates have been traversed. In a case that fiducial detection is not complete, operation may return to calculating 202 a location (for a next grid coordinate, for instance). In a case that fiducial detection is complete, operation may end 218.

In a case that the image coordinate quantity satisfies the threshold, the apparatus may calculate 210 a homography between the image coordinates and the grid coordinates. In some examples, calculating the homography 210 may be performed as described in relation to FIG. 1.

The apparatus may calculate 212 a location based on the homography. In some examples, calculating 212 the homography may be accomplished as described in relation to FIG. 1. For example, the apparatus may multiply the grid coordinate (e.g., grid coordinate of an unidentified fiducial) with the homography to produce the location.

The apparatus may determine 214 whether a location of candidate fiducial (e.g., nearest candidate fiducial) is within a threshold distance from the calculated location. In a case that the location of the candidate fiducial is not within the threshold distance, the apparatus may determine 216 whether fiducial detection is complete.

In a case that the location of the candidate fiducial is within the threshold distance, the apparatus may map 220 the candidate fiducial to a grid coordinate. In some examples, mapping 220 the candidate fiducial to a grid coordinate may be accomplished as described in relation to FIG. 1. For example, the apparatus may add the image coordinate of the candidate fiducial to a mapped set in association with the grid coordinate. The apparatus may determine 216 whether fiducial detection is complete and return to calculating 202 a location for a next grid coordinate or end 218 operation. In some examples, performing fiducial location may result in the fiducial marks being approximately aligned to a global grid. For instance, a homography or homographies may be utilized to approximately align the fiducial marks of the image to a global grid.

In some examples, in a case that fiducial detection is complete, the apparatus may perform an operation using the fiducial pattern. Some examples of an operation may include decoding data marks (e.g., dots) relative to the fiducial pattern, determining an attribute or attributes of the object based on the fiducial pattern, and/or printing a representation of the object based on the fiducial pattern.

In some examples, the apparatus may decode data marks relative to the fiducial pattern. Data marks are marks that indicate information. Examples of data marks may include dots, lines, crosses, characters, and/or symbols. In some examples, data marks may be encoded according to a spatial relationship relative to fiducial marks. For example, marks on an object may include data marks and fiducial marks. In some examples, a grid (e.g., virtual grid) may be formed from detected fiducial dots as described herein. The fiducial dots may be aligned along approximately orthogonal axes that form virtual square unit cells in a fiducial pattern. In some examples, a data dot or data dots may appear within each cell. For instance, a data dot may be placed at any one of nine vertices of a 3×3 virtual array within each cell. The location of the data dot within each cell of the alignment grid may encode one of nine data symbols. In some examples, other data mark positions relative to the fiducial pattern may be defined and/or more than one data mark may be provided within a cell. In some examples, the apparatus may decode a data mark by determining a data mark position relative to the fiducial pattern and selecting a corresponding data symbol. For instance, the apparatus may decode data dots relative to the fiducial pattern.

In some examples, the apparatus may determine an attribute of the object based on the fiducial pattern. Examples of an attribute of an object may include object shape, object pose (e.g., position and/or orientation), surface depth, etc. For instance, the apparatus may determine object shape based on image subsets as indicated in relation to the fiducial pattern. For example, a projection of the fiducial pattern may indicate object shape (e.g., approximate surface plane orientation) in each image subset. In some examples, the apparatus may utilize the fiducial pattern to determine object pose. For instance, the apparatus may determine the position and/or orientation of the object in three-dimensional (3D) space relative to the fiducial pattern of the image subsets. In some examples, the apparatus may utilize the fiducial pattern to determine surface depth of an object. For example, the projection(s) of the fiducial pattern corresponding to the image subsets may indicate a depth of each fiducial mark (according to a geometric relationship with the homography).

In some examples, performing the operation(s) may include displaying data, sending data, and/or printing based on the fiducial pattern. For example, the apparatus may display data on a display (and/or send data to a display) that indicates decoded data, object shape, object pose, and/or surface depth. For instance, decoded data may indicate a name, a type, a date, ownership, a brand, a price, other information, etc. For example, the decoded data may indicate the name and price of an object indicated by data dots. In some examples, the apparatus may render a representation (e.g., a 3D model) of the object and display the representation on a display and/or send the representation to another device (e.g., remote device, networked device, etc.). For instance, the apparatus may utilize the pose, surface, and/or depth data to render the representation (e.g., an image of a 3D model in a 3D space). In some examples, the apparatus may utilize the pose, surface, and/or depth data to print a 2D and/or 3D representation of the object. In some examples, an element or elements of the method 200 may be omitted or combined.

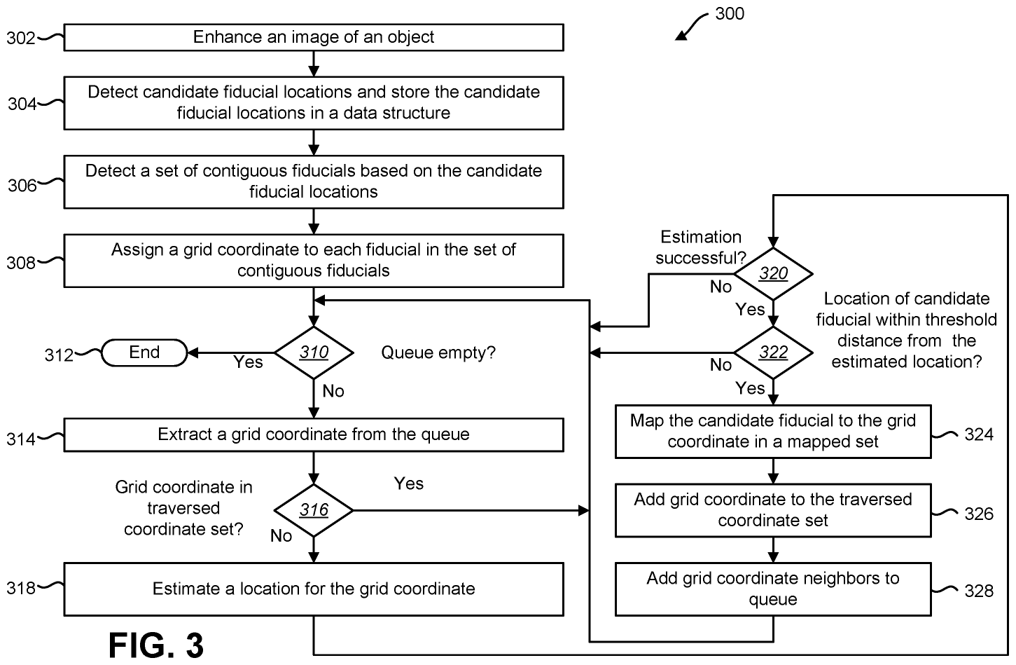

FIG. 3 is a flow diagram illustrating an example of a method 300 for estimating fiducial location based on grid coordinates. The method 300 may be an example of the method 100 described in relation to FIG. 1. The method 300 and/or a method 300 element or elements may be performed by an apparatus (e.g., electronic device, computing device, server, smartphone, laptop computer, tablet device, scanning device, etc.). For example, the method 300 may be performed by the apparatus 402 described in relation to FIG. 4.

The apparatus may enhance 302 an image of an object. In some examples, enhancing 302 the image may be performed as described in relation to FIG. 1.

The apparatus may detect 304 candidate fiducial locations and store the candidate fiducial locations in a data structure. In some examples, detecting 304 the candidate fiducial locations may be performed as described in relation to FIG. 1. For example, the apparatus may detect marks that may be designated as candidate fiducial locations.

The apparatus may detect 306 a set of contiguous fiducials based on the candidate fiducial locations. In some examples, detecting 306 the set of contiguous fiducials may be performed as described in relation to FIG. 1. For example, the apparatus may designate candidate fiducials within a selected fiducial pattern subset as contiguous fiducials. In some examples, the set of contiguous fiducials may be an initial set of contiguous fiducials.

The apparatus may assign 308 a grid coordinate to each fiducial in the set of contiguous fiducials. In some examples, assigning 308 the grid coordinates may be performed as described in relation to FIG. 1. In some examples, the apparatus may store the grid coordinates in a queue. For instance, initial grid coordinates corresponding to the initial set of contiguous fiducials may be stored in the queue in some approaches. In some examples, initial grid coordinates may not be initially stored in the queue. The queue may or may not initially store grid coordinates corresponding to an identified fiducial or fiducials. In some examples, the apparatus may store the grid coordinates or a subset of the grid coordinates in a traversed coordinate set. In some examples, the apparatus may add, to the queue, a neighboring grid coordinate or neighboring grid coordinates of a grid coordinate or grid coordinates in the traversed coordinate set. The queue may include a grid coordinate or grid coordinates corresponding to an unidentified fiducial or unidentified fiducials in some examples.

The apparatus may determine 310 whether the queue is empty. For example, the apparatus may determine whether the queue includes a grid coordinate or grid coordinates. In a case that the queue is empty, operation may end 312.

In a case that the queue is not empty, the apparatus may extract 314 a grid coordinate from the queue. For example, the apparatus may pop a grid coordinate from the queue (in first-in-first-out (FIFO) order, for instance).

The apparatus may determine 316 whether the grid coordinate (e.g., the current or popped grid coordinate) is in a traversed coordinate set (e.g., hash set). For example, the apparatus may determine whether the grid coordinate matches any grid coordinate in the traversed coordinate set. In a case that the grid coordinate is in the traversed coordinate set, operation may return to determining 310 whether the queue is empty.

In a case that the grid coordinate is not in the traversed coordinate set, the apparatus may estimate 318 a location for the grid coordinate. In some examples, estimating 318 the location may be performed as described in relation to FIG. 1 and/or FIG. 2.

The apparatus may determine 320 whether estimation was successful. In some examples, determining 320 whether estimate was successful may be performed as described in relation to FIG. 1 and/or FIG. 2. For instance, the apparatus may determine whether estimating 318 the location has resulted in “none” or a failure. In a case that estimation failed or was not successful, operation may return to determining 310 whether the queue is empty.

In a case that estimation was successful, the apparatus may determine 322 whether a location of a candidate fiducial (e.g., nearest candidate fiducial) is within a threshold distance from the estimated location. In some examples, determining 322 whether the location of a candidate fiducial is within the threshold distance may be accomplished as described in relation to FIG. 1 and/or FIG. 2. In a case that the location of a candidate fiducial is not within the threshold distance, operation may return to determining 310 whether the queue is empty.

In a case that the location of the candidate fiducial is within the threshold distance, the apparatus may map 324 the candidate fiducial to a grid coordinate in a mapped set. In some examples, mapping 324 the candidate fiducial to a grid coordinate may be accomplished as described in relation to FIG. 1 and/or FIG. 2.

The apparatus may add 326 the grid coordinate to the traversed coordinate set. In some examples, adding 326 the grid coordinate to the traversed coordinate set may be accomplished as described in relation to FIG. 1. In some examples, the apparatus may add 326 the grid coordinate to the traversed coordinate set in response to determining that the candidate fiducial is a fiducial.

The apparatus may add 328 grid coordinate neighbors to the queue. In some examples, adding 328 the grid coordinate neighbors to the queue may be accomplished as described in relation to FIG. 1. In some examples, the grid coordinate neighbor(s) may include a grid coordinate or coordinates corresponding to an unidentified fiducial or unidentified fiducials and/or an identified fiducial and/or identified fiducials. For example, a neighbor or neighbors of a fiducial or fiducials (e.g., identified fiducial(s)) may be added to the queue. Operation may return to determining 310 whether the queue is empty. In some examples, the method 300 may include performing an operation or operations based on a fiducial pattern as described in relation to FIG. 2. In some examples, an element or elements of the method 300 may be omitted or combined.

FIG. 4 is a block diagram of an example of an apparatus 402 that may be used in fiducial location. The apparatus 402 may be an electronic device, such as a personal computer, a server computer, a smartphone, a tablet computer, scanning device, etc. The apparatus 402 may include and/or may be coupled to a processor 404 and/or a memory 406. The apparatus 402 may include additional components (not shown) and/or some of the components described herein may be removed and/or modified without departing from the scope of this disclosure.

The processor 404 may be any of a central processing unit (CPU), a digital signal processor (DSP), a semiconductor-based microprocessor, graphics processing unit (GPU), field-programmable gate array (FPGA), an application-specific integrated circuit (ASIC), and/or other hardware device suitable for retrieval and execution of instructions stored in the memory 406. The processor 404 may fetch, decode, and/or execute instructions stored in the memory 406. In some examples, the processor 404 may include an electronic circuit or circuits that include electronic components for performing a function or functions of the instructions. In some examples, the processor 404 may be implemented to perform one, some, or all of the aspects, operations, elements, etc., described in relation to one, some, or all of FIGS. 1-9.

The memory 406 is an electronic, magnetic, optical, and/or other physical storage device that contains or stores electronic information (e.g., instructions and/or data). The memory 406 may be, for example, Random Access Memory (RAM), Electrically Erasable Programmable Read-Only Memory (EEPROM), a storage device, an optical disc, and/or the like. In some examples, the memory 406 may be volatile and/or non-volatile memory, such as Dynamic Random Access Memory (DRAM), EEPROM, magnetoresistive random-access memory (MRAM), phase change RAM (PCRAM), memristor, flash memory, and/or the like. In some implementations, the memory 406 may be a non-transitory tangible machine-readable storage medium, where the term “non-transitory” does not encompass transitory propagating signals. In some examples, the memory 406 may include multiple devices (e.g., a RAM card and a solid-state drive (SSD)).

In some examples, the apparatus 402 may include a communication interface 424 through which the processor 404 may communicate with an external device or devices (e.g., networked device, server, smartphone, printer, etc.). In some examples, the apparatus 402 may be in communication with (e.g., coupled to, have a communication link with) an image sensor. In some examples, the apparatus 402 may include an integrated image sensor.

The communication interface 424 may include hardware and/or machine-readable instructions to enable the processor 404 to communicate with the external device or devices. The communication interface 424 may enable a wired and/or wireless connection to the external device or devices. In some examples, the communication interface 424 may include a network interface card and/or may also include hardware and/or machine-readable instructions to enable the processor 404 to communicate with various input and/or output devices. Examples of output devices include a printer, a 3D printer, a display, etc. Examples of input devices include a keyboard, a mouse, a touch screen, etc., through which a user may input instructions and/or data into the apparatus 402.

In some examples, the memory 406 of the apparatus 402 may store image data 408, dot data 410, dot detection instructions 412, fiducial dot subset determination instructions 414, dot location determination instructions 416, and/or extension instructions 418. The image data 408 is data that indicates an image or images. For example, the image data 408 may indicate or depict an object or objects with marks (e.g., dots). The dot data 410 is data that indicates dots of an object or objects. For example, the dot data 410 may indicate positions of detected dots in the image data 408.

The dot detection instructions 412 are instructions to detect dots in an image or images of an object or objects. In some examples, the dot detection instructions 412 may include executable code to detect the locations of dots in an image. In some examples, the processor 404 may execute the dot detection instructions 412 to detect locations of dots in an image of an object as described in relation to FIG. 1, FIG. 2, and/or FIG. 3. For instance, the processor 404 may enhance and/or filter an image or images. In some examples, the processor 404 may detect the dots by determining peaks and/or locations in the image(s) that meet a criterion or criteria. The detected dots (e.g., dot positions) may be stored as dot data 410 in memory 406.

The fiducial dot subset determination instructions 414 are instructions to determine fiducial dot subsets of the dots in image subsets of the image. For example, a fiducial dot subset may be an example of the fiducial pattern subsets, identified fiducials, and/or contiguous pattern structures described herein. In some examples, the processor 404 may execute the fiducial dot subset determination instructions 414 to determine fiducial dot subsets in image subsets as described in relation to FIG. 1, FIG. 2 and/or FIG. 3. For instance, the processor 404 may detect line crossings from groups of five dots, where a fiducial dot subset may include dots corresponding to a detected line crossing or connected line crossings.

In some examples, the dot location determination instructions 416 are instructions to determine a location of a fiducial dot based on neighboring image space coordinates corresponding to neighboring integer space coordinates. For example, the processor 404 may utilize image coordinates corresponding to neighboring grid coordinates to estimate a location of a fiducial dot (e.g., unidentified fiducial). In some examples, the dot location determination instructions 416 are instructions to determine a location of a fiducial dot based on first image space coordinates corresponding to first integer space coordinates within a window. For example, the processor 404 may utilize image coordinates corresponding to grid coordinates within a window to estimate a location of a fiducial dot (e.g., unidentified fiducial). In some examples, the processor 404 may execute the location determination instructions 416 to determine fiducial dot location(s) as described in relation to FIG. 1, FIG. 2 and/or FIG. 3.

The extension instructions 418 are instructions to extend the fiducial dot subset based on image space coordinates and integer space coordinates of the fiducial dot subset. In some examples, the processor 404 may execute the extension instructions 418 to extend the fiducial dot subset as described in relation to FIG. 1, FIG. 2, and/or FIG. 3. For instance, the processor 404 may add neighboring grid coordinates and determine whether there are unidentified fiducial dots corresponding to the neighboring grid coordinates. In some examples, an element or elements of the apparatus 402 may be omitted or combined.

Some examples of the techniques described herein may be utilized to provide fiducial pattern detection on curved surfaces. Some examples of the techniques described herein may enable fiducial pattern detection without prior information regarding surface curvature and/or shape. Some examples of the techniques described herein may enable relatively fast fiducial pattern detection with relatively low computational complexity compared with other approaches. Some examples of the techniques described herein may allow 3D fiducial and/or data marking that is not restricted to planar surfaces and/or flat regions. For example, 3D fiducial marking and/or data marking may be placed on and/or recoverable from curved surfaces and/or non-planar surfaces. For example, fiducial marks and/or data marks may appear as a visual wrapping on a curved object.

Some examples of the techniques described herein may be utilized to align features in a quasi-periodic arrangement, such as grids of fiducial markings rendered in relief as part of a visually significant barcode (VSB) structure, in order to resolve the coordinate system of a 3D rendered surface. Some examples may provide a framework for combining local (affine) transform estimates to help interpret a global coordinate system mapping between an object's surface and an image of the surface. Some examples may utilize computation in a single pass over detected features. Accordingly, the imagery of the surface may be evaluated based on demand and/or control parameters that determine the aggressiveness of the estimates may be adapted smoothly as more features are included via the set of resolved locations. Some examples may provide the extraction of encoded information via surface manipulation techniques on a wider selection of non-flat surfaces, as there may be a reduced sensitivity to piecewise alignment parameter estimation. Some examples may provide improvements for 2D applications (e.g., color encodings via dot signatures) in the presence of image content occlusions.

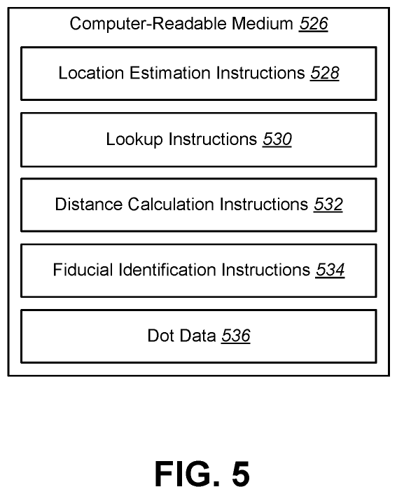

FIG. 5 is a block diagram illustrating an example of a computer-readable medium 526 for determining fiducial location. The computer-readable medium 526 is a non-transitory, tangible computer-readable medium. The computer-readable medium 526 may be, for example, RAM, EEPROM, a storage device, an optical disc, and the like. In some examples, the computer-readable medium 526 may be volatile and/or non-volatile memory, such as DRAM, EEPROM, MRAM, PCRAM, memristor, flash memory, and the like. In some implementations, the memory 406 described in relation to FIG. 4 may be an example of the computer-readable medium 526 described in relation to FIG. 5.

The computer-readable medium 526 may include code (e.g., data and/or instructions). For example, the computer-readable medium 526 may include location estimation instructions 528, lookup instructions 530, distance calculation instructions 532, fiducial identification instructions 534, and/or dot data 536. The dot data 536 is data indicating positions of dots in an image or images.

The location estimation instructions 528 may include code to cause a processor to estimate a first location of an unidentified fiducial based on image coordinates and grid coordinates of a set of fiducials. In some examples, the first location may be estimated as described in relation to FIG. 1, FIG. 2, FIG. 3, and/or FIG. 4. In some examples, the location estimation instructions 528 may include code to cause the processor to calculate image coordinate estimates based on pairs of neighboring fiducials and code to cause the processor to average the image coordinate estimates to estimate the first location. In some examples, the location estimation instructions 528 may include code to cause the processor to determine that a location result is invalid and code to cause the processor to utilize image coordinates corresponding to grid coordinates within a window to estimate the first location in response to determining that the location result is invalid

The lookup instructions 530 may include code to cause the processor to look up a second location of a candidate fiducial in an array based on the first location. In some examples, second location may be looked up as described in relation to FIG. 1, FIG. 2, FIG. 3, and/or FIG. 4. For instance, a processor may round coordinates of the first location to look up the second location in an array.

The distance calculation instructions 532 may include code to cause the processor to calculate a distance between the first location and the second location. In some examples, calculating the distance may be determined as described in relation to FIG. 1, FIG. 2, FIG. 3, and/or FIG. 4. For example, the processor may determine a Euclidean distance between the first location and the second location.

The fiducial identification instructions 534 may include code to cause the processor to determine that the candidate fiducial is a fiducial based on the distance. In some examples, determining that the candidate fiducial is a fiducial may be performed as described in relation to FIG. 1, FIG. 2, FIG. 3, and/or FIG. 4. For example, the fiducial identification instructions 534 may include code to cause a processor to determine whether the distance is within a distance threshold.

FIG. 6 is a diagram illustrating an example of a line crossing 638 in accordance with some examples of the techniques described herein. Examples of fiducial dots 640a-i are illustrated. Examples of data dots 642a-d are also illustrated. The line crossing 638 may be detected in accordance with some examples of the techniques described herein.

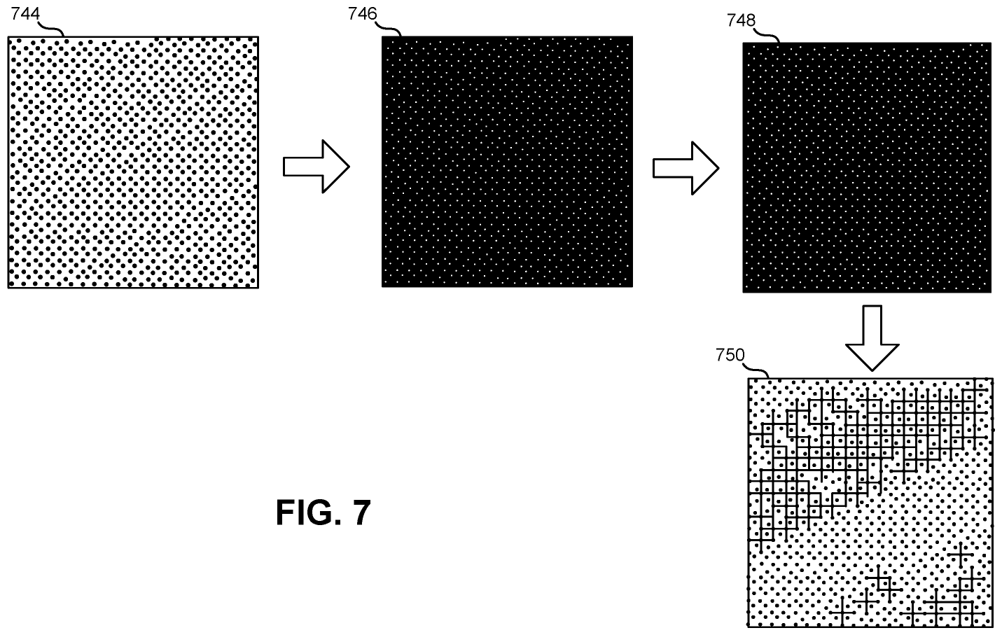

FIG. 7 is a diagram illustrating an example of an image subset 744 in accordance with some examples of the techniques described herein. The image subset 744 may include dots. In some examples, the dots may be dot halftones of a flat gray image. In some examples, a portion (e.g., approximately half) of the dots may be included in a fiducial pattern, and another portion (e.g., approximately half) may be data dots that may represent embedded data. In some examples, marks indicating information or data dots may be referred to as carriers. In some examples, the fiducial dots may serve as anchors for recovery of the data dots and/or may blend into the halftone pattern. The fiducial dots may be useful for non-planar surfaces due to the unpredictable orientation distortions imparted by general surfaces. In some examples, the fiducial dots may be aligned for data recovery.

To handle general surfaces, which may include non-planar (e.g., curved) surfaces, an image may be divided into image subsets. In some examples, image subsets may correspond to curved areas of an object that can be approximated as planar. In some examples, fiducial pattern detection (e.g., grid detection) may be performed for each of the image subsets as described herein. FIG. 7 provides an example of fiducial pattern detection for an image subset 744. For example, the image subset 744 may be a portion of a captured image (e.g., captured digital image). For example, an image may be divided into image subsets of a smaller size that may allow a curved surface to be approximated as planar.

In some examples, the image subset 744 may be enhanced to reduce noise and/or to amplify the locations of the dots using a DoG filter and/or DoG operator. An example of an enhanced image subset 746 is illustrated in FIG. 7. For instance, the image subset 744 may be enhanced to produce the enhanced image subset 746. In some examples, dot detection may be performed based on the enhanced image subset 746. For instance, dot detection may be performed on the enhance image subset 746 to produce detected dot positions 748 as illustrated in FIG. 7.

In some examples, line crossings may be detected to isolate the fiducial dots from the data dots. For example, a line crossing may include 5 fiducial dots at intersections of lines formed by approximately orthogonal lines. An example of the image subset with detected line crossings 750 is illustrated in FIG. 7.

In some examples, a connected set of line crossings may be determined. For example, contiguous pattern structures may be selected.

FIG. 8A is a diagram illustrating an example of a first approach 856a for determining fiducial location. The first approach 856a may enable estimating the image coordinate of an unidentified fiducial 862a corresponding to a grid coordinate. Assume the unidentified fiducial 862a has a corresponding grid coordinate (m, n). In some examples of the techniques described herein, an apparatus may attempt to find four pairs of neighboring fiducials 858a-g around the unidentified fiducial 862a. For example, a pair of neighboring fiducials 858a-b may be located to the “north” of the unidentified fiducial 862a, with corresponding grid coordinates (m, n+1) and (m, n+2). In some cases, an unidentified fiducial 862a may not have all 8 neighboring fiducials. For example, an unidentified neighboring fiducial 860 is illustrated in FIG. 8A. An unidentified neighboring fiducial 860 may not have been detected and/or may not have been processed. Accordingly, a pair including a neighboring fiducial 858c and an unidentified neighboring fiducial 860 may not be used for estimating the location of the unidentified fiducial 862a. For example, an apparatus may retrieve image coordinates k₁ and k₂ from a data structure (e.g., dictionary) corresponding to neighboring fiducial pairs 858a-b, 858d-e, 858f-g. For each of the pairs, 2k₁-k2 may be the estimated image coordinate of the unidentified fiducial 862a. Due to the unidentified neighboring fiducial 860, 2k₁-k₂ may not be utilized to determine an estimated image coordinate of the unidentified fiducial 862a based on the neighboring fiducial 858c and the unidentified neighboring fiducial 860. Because 0-4 pairs may be utilized in some cases, 0-4 estimated image coordinates may be determined. A value, an average (e.g., mean) value, or “none” may be determined as an estimated location in image coordinates. The first approach 856a may be computationally fast and robust against curvature. In some circumstances, the first approach 856a may fail. For example, the first approach 856a may fail if a whole row or column of fiducials are unidentified, which may result in fiducial location detection that stops at the gap.

FIG. 8B is a diagram illustrating an example of a second approach 856b for determining fiducial location. The second approach 856b may enable estimating the image coordinate of an unidentified fiducial 862b corresponding to a grid coordinate based on fiducials 863a-w within a window. In some examples, the second approach 856b may be a backup approach to deal with cases where another approach fails. For instance, if the example of FIG. 8A had more unidentified neighboring fiducials than shown, thereby causing the first approach 856a to fail, the second approach 856b may be utilized. The apparatus may find fiducials 863a-w within a window with a window size N*N (5×5 in FIG. 8B) centered at the unidentified fiducial 862b. An example with the window size 5×5 is illustrated in FIG. 8B. If 2N or more identified fiducials 863a-w are found within the window (without another unidentified fiducial 865, for instance), the apparatus may calculate a homography between the grid coordinates of the fiducials 863a-w and corresponding image coordinates. The estimated image coordinate of the unidentified fiducial 862b may be calculated by multiplying the homography and the grid coordinate of the unidentified fiducial 862b. Some examples may utilize N=5 as illustrated in FIG. 8B. Some examples may utilize a different window size. For instance, with N≥7, some examples of the techniques described herein may handle a whole row or column of unidentified fiducials.

The apparatus may utilize the estimated image coordinate location to find a location of a candidate fiducial that is nearest to the estimated image coordinate location. The candidate fiducial may be relatively close. For example, a distance threshold T (e.g., T=D/8) may be utilized, where D is an average distance between two adjacent fiducials around the unidentified fiducial 862b.

Some examples of the techniques described herein may enable handling fiducial patterns embedded onto a larger class of quasi-random surfaces. Some examples may tolerate high surface curvature. Some examples may enable surface-independent, efficient, and/or scalable feature computation and analysis. Some examples may expand a class of surfaces where data may be suitably encoded. Some examples may provide continuous adaptation of region-growing control parameters. Some examples may avoid multi-pass processing to determine alignment parameters from separate regions.

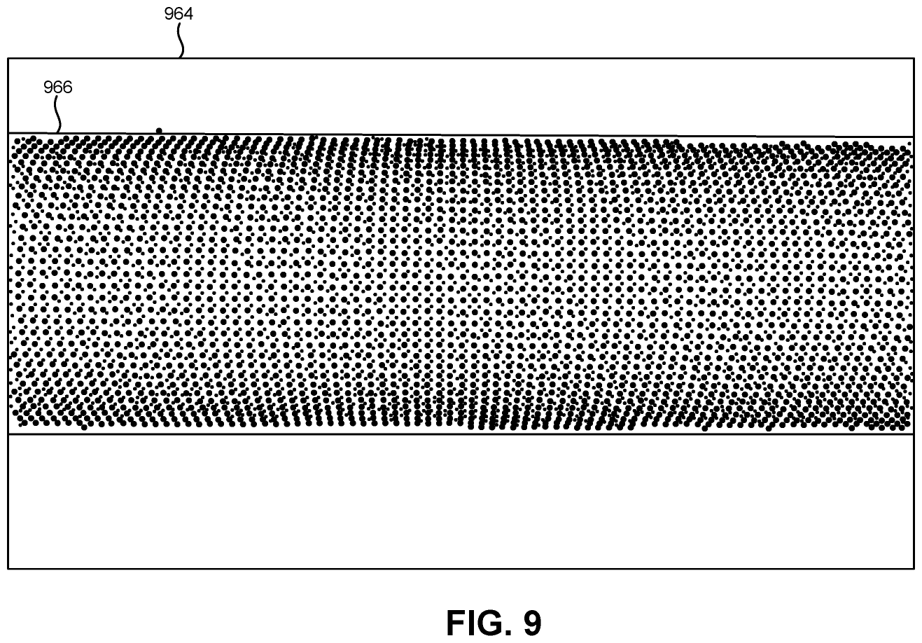

FIG. 9 is a diagram illustrating an example of an image 964 of a cylindrical object 966 with a detected fiducial pattern in accordance with some examples of the techniques described herein. For instance, the image 964 may be captured with a mobile device. The cylindrical object 966 is a 1-inch radius cylinder with a camera distance of 6 inches. In the example of FIG. 9, the fiducial pattern has a rotation angle of 0 degrees (e.g., the axes of the fiducial pattern are situated at 0 degrees with respect to the major axis of the cylinder). The cylinder axis is approximately horizontal, and edges of the cylinder are in the field of view. In this example, heavier dots correspond to fiducial dots detected in accordance with some examples of the techniques described herein, and lighter dots correspond to data dots. Some examples of the techniques described herein may also work when a row or rows of fiducials are blocked.

While various examples are described herein, the described techniques are not limited to the examples. Variations of the examples described herein may be implemented within the scope of the disclosure. For example, operations, functions, aspects, or elements of the examples described herein may be omitted or combined.

1. A method, comprising:
estimating a first location of an unidentified fiducial based on image coordinates and grid coordinates of a set of contiguous fiducials; and
determining that a candidate fiducial is a fiducial based on comparing the first location with a second location of the candidate fiducial.

2. The method of claim 1, wherein estimating the first location of the unidentified fiducial comprises calculating the first location based on an image coordinate pair or pairs corresponding to a neighboring grid coordinate pair or pairs.

3. The method of claim 1, wherein comparing the first location with the second location of the candidate fiducial comprises determining that the second location of the candidate fiducial is within a threshold distance from the first location.

4. The method of claim 1, wherein estimating the first location of the unidentified fiducial comprises:
finding first image coordinates corresponding to first grid coordinates within a window centered at the unidentified fiducial;
calculating a homography between the first image coordinates and the first grid coordinates; and
calculating the first location based on the homography.

5. The method of claim 4, wherein calculating the homography is performed in response to determining that a quantity of the first image coordinates satisfies a threshold.

6. The method of claim 1, further comprising:
detecting the set of contiguous fiducials, wherein the set of contiguous fiducials is an initial set of contiguous fiducials;
assigning a grid coordinate to each fiducial in the set of contiguous fiducials; and
storing the grid coordinates or a subset of the grid coordinates in a traversed coordinate set.

7. The method of claim 6, further comprising adding, to a queue, a neighboring grid coordinate or coordinates of a grid coordinate or coordinates in the traversed coordinate set.

8. The method of claim 7, further comprising adding a first grid coordinate to the traversed coordinate set in response to determining that the candidate fiducial is a fiducial.

9. The method of claim 7, further comprising adding a neighboring grid coordinate or coordinates of the first grid coordinate to the queue.

10. An apparatus, comprising:
a memory; and
a processor coupled to the memory, wherein the processor is to:
detect dots in an image of an object;
determine a fiducial dot subset of the dots; and
extend the fiducial dot subset based on image space coordinates and integer space coordinates of the fiducial dot subset.

11. The apparatus of claim 10, wherein the processor is to determine a location of a fiducial dot based on neighboring image space coordinates corresponding to neighboring integer space coordinates.

12. The apparatus of claim 10, wherein the processor is to determine a location of a fiducial dot based on first image space coordinates corresponding to first integer space coordinates within a window.

13. A non-transitory tangible computer-readable medium storing executable code, comprising:
code to cause a processor to estimate a first location of an unidentified fiducial based on image coordinates and grid coordinates of a set of fiducials;
code to cause the processor to look up a second location of a candidate fiducial in an array based on the first location;
code to cause the processor to calculate a distance between the first location and the second location; and
code to cause the processor to determine that the candidate fiducial is a fiducial based on the distance.

14. The computer-readable medium of claim 13, wherein the code to cause the processor to estimate the first location comprises:
code to cause the processor to calculate image coordinate estimates based on pairs of neighboring fiducials; and
code to cause the processor to average the image coordinate estimates to estimate the first location.

15. The computer-readable medium of claim 14, wherein the code to cause the processor to estimate the first location comprises:
code to cause the processor to determine that a location result is invalid; and
code to cause the processor to utilize image coordinates corresponding to grid coordinates within a window to estimate the first location in response to determining that the location result is invalid.
